(19) United States
(12) Patent Application Publication
(10) Pub. No.: US 2025/0343463 A1
(43) Pub. Date: Nov. 6, 2025

(54) MOBILE POWER STATION

(71) Applicant: PHOS GLOBAL ENERGY SOLUTIONS, INC., Fort Lauderdale, FL (US)

(72) Inventors: Eugene Earle Rudolph, Port Jefferson Station, NY (US); Victor Bica, Saint James, NY (US)

(73) Assignee: PHOS GLOBAL ENERGY SOLUTIONS, INC., Fort Lauderdale, FL (US)

(21) Appl. No.: 18/993,432

(22) PCT Filed: Jul. 11, 2023
(86) PCT No.: PCT/US2023/027365

§ 371 Date: Jan. 10, 2025

Related U.S. Application Data
(60) Provisional application No. 63/388,222, filed on Jul. 11, 2022.

(51) Int. Cl. H02K 7/18; H02K 5/10; H02K 7/02; H02K 9/19

(52) U.S. Cl. CPC H02K 7/1807; H02K 5/10; H02K 7/025; H02K 9/19

(57) ABSTRACT

A remote energy system including a container, the container including a partition separating the container into a generator side and an energy storage side, a motor secured in the energy storage side of the container, the motor configured to receive energy from one or more renewable energy sources, a flywheel assembly magnetically coupled to the motor, the flywheel assembly configured to store kinetic energy, an electrical generator magnetically coupled to the motor or the flywheel and configured to supply electrical energy to a load, and a fuel powered generator secured in the generator side of the container and configured to provide electrical energy to the motor.

### CROSS-REFERENCE TO RELATED APPLICATIONS

The instant application is a National Phase application of PCT/US2023/027365 filed Jul. 11, 2023, which claims priority to U.S. Provisional Application No. 63/388,222 filed Jul. 11, 2022, bearing the title MOBILE POWER STATION. Further, this application is related to Patent Cooperation Treaty Application No. WO 2021/096470 filed Aug. 14, 2020, and PCT/US2022/029255 filed May 13, 2022, the entire contents of which are incorporated herein as if set forth fully particularly the descriptions of flywheels and their various uses for storage and allocation of energy on demand.

### TECHNICAL FIELD

This disclosure relates generally to mobile power stations, and in particular to mobile power stations employing mechanical energy storage devices.

### BACKGROUND

Both the military and first responders employ remote camp systems for providing shelter and other accommodations in a variety of environments. These remote camps are used in the military for forward deployments where personnel return to from patrols and other missions. In the civilian world these camps are employed in times of emergency and natural disaster where local facilities are either unsafe or unusable.

Many such camps are tent based, allowing them to be trucked or air-lifted to the desired site. Typically, these remote camp systems employ one or more gas or diesel generators to provide power. A typical gas or diesel generator may be, for example, a 3.5 kW generator capable of handling basic hotel loads (e.g., lighting, air conditioning, and electrical power for rechargeable devices).

The constant running of these relatively small and portable generators creates a significant amount of noise in the camp making sleep and other activities challenging. Further, such small generators require consistent and regular refueling. As will be appreciated, fuel becomes an important resource to be managed by the personnel at the camp. However, as a tent-based solution, the effect of any air conditioning is quickly lost, increasing the power and thus fuel demands. Further, such tent-based solutions require a not insignificant amount of set-up to make the tents useable. In short, anyone who has spent any amount of time in such forward deployment or emergency situations can attest that while the tents utilized provide some shelter, they do not provide a great deal of comfort.

The instant disclosure is directed at providing solutions to challenges these camps present to the military and first responders.

### SUMMARY

One aspect of the disclosure is directed to a remote energy system, the remote energy system also includes a container, the container including a partition separating the container into a generator side and an energy storage side; a motor secured in the energy storage side of the container, the motor configured to receive energy from one or more renewable energy sources; a flywheel assembly magnetically coupled to the motor, the flywheel assembly configured to store kinetic energy; an electrical generator magnetically coupled to the motor or the flywheel and configured to supply electrical energy to a load; and a fuel powered generator secured in the generator side of the container and configured to provide electrical energy to the motor. Other embodiments of this aspect include corresponding computer systems, apparatus, and computer programs recorded on one or more computer storage devices, each configured to perform the actions of the methods and systems described herein.

Implementation of this aspect of the disclosure may include one or more of the following features. The remote energy system further including a plurality of solar panels electrically connected to the motor. The plurality of solar panels is secured to the roof of the container. The remote energy system further including a plurality of foldable structures. Each foldable structure supports a second plurality of solar panels. The remote energy system further including a wind turbine generator electrically connected to the motor. The remote energy system further including a water storage tank and heat exchanger operably connected to the generator to cool the generator. The heat exchanger is configured to prevent ingress of air into the container. The remote energy system further including an air inlet, the air inlet including a filter limiting ingress of sand and dirt into the container. The remote energy system further including an exhaust fan exhausting air from the energy storage side of the container. The flywheel assembly includes a flywheel storing about 25 kwh of energy. The flywheel assembly includes a pair of flywheels storing about 50 kwh of energy. The fuel powered generator generates about 50 kw. The remote energy system further including an electrical control cabinet, the electrical control cabinet enabling the connection of the electrical generator with a load external to the container such that kinetic energy stored in the flywheel is converted to electrical energy and applied to the load. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a top perspective view of an energy storage system in accordance with the disclosure;

FIG. 2 is a bottom perspective view of the energy storage system of FIG. 1;

FIG. 3 is an top perspective view of the energy storage system of FIG. 1, with the top removed and the doors opened;

FIG. 4 is a side perspective view of the energy storage system of FIG. 1;

FIG. 5 is a side perspective view of the energy storage system of FIG. 1;

FIG. 6 is a front perspective view of the energy storage system of FIG. 1;

FIG. 7 is rear perspective view of the energy storage system of FIG. 1;

FIG. 8 is a top perspective view of the energy storage system of FIG. 1, with the top removed and the doors opened; and

FIG. 9 is a front perspective view of an energy storage system in accordance with the disclosure.

### DETAILED DESCRIPTION

Embodiments of the disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

Renewable energy has become an increasingly important source of electrical energy generation in many countries around the world. As the demand for electrical energy has increased, the impact of fossil fuels on the environment has become magnified and increasingly apparent. In an effort to overcome these obstacles, advancements in green energy generation have continued to accelerate, resulting in innovations such as photovoltaic or solar panels, wind turbine generators, and others. Regardless of the generation source, unless the energy produced is to be used immediately there needs to be some method of energy storage. Current energy storage systems are primarily focused on batteries including lead-acid, absorbent glass mat, lithium-ion (in a variety of chemistries), vanadium flow, and others. However, batteries have multiple drawbacks including their weight, the use of toxic and hazardous chemistries, potential for fire, relatively short life span, and energy dissipation even when not being used.

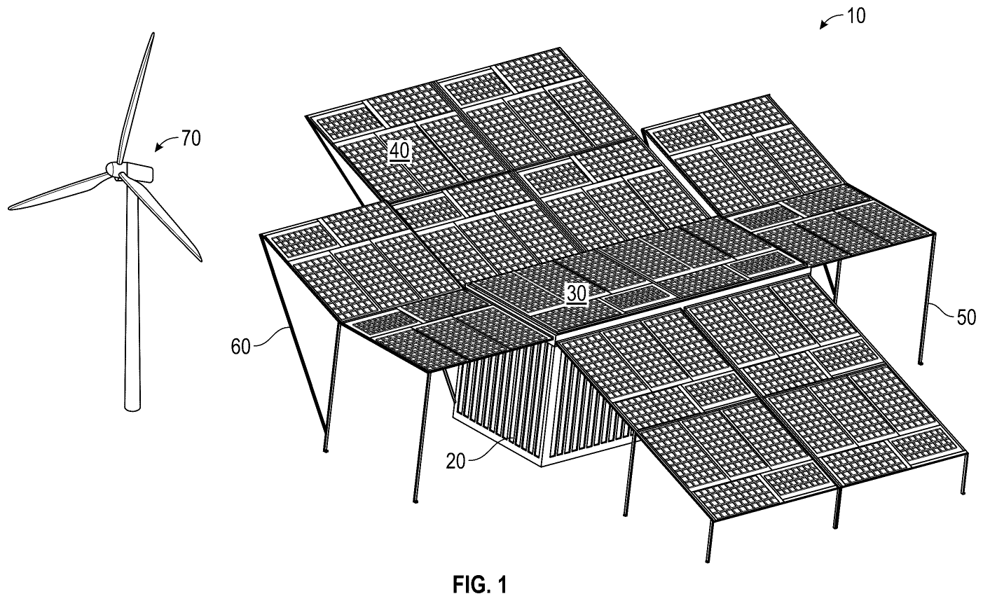

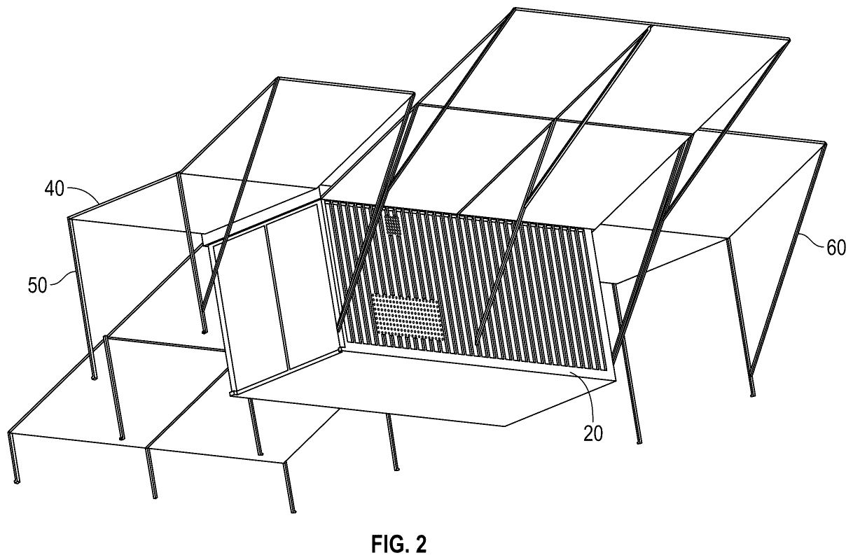

This disclosure is directed to a portable containerized camp energy generation incorporating one or more of the renewable energy sources in combination with a mechanical energy storage system. FIG. 1 depicts a top perspective view of a camp energy generation and storage solution 10 in accordance with the disclosure, similarly FIG. 2 depicts a bottom perspective view of the camp energy solution 10. The camp energy solution 10 is based on a standard container 20 such as a 20-foot shipping container. Mounted on the roof of the container 20 are a number of photovoltaic modules or solar panels 30. As depicted in FIG. 1, the solar panels 30 are mounted in a folding fashion to the roof of the container. Using standard solar panels 30, approximately 6 can be secured directly to the roof of the container. With each solar panel 30 producing between 300 and 400 Watts (W), the output of the solar panels is up to about 2.4 kW under maximum conditions.

As is known the solar panels 30 operate more efficiently the more they face directly at the sun. In accordance with the disclosure, foldable support structures 40 supported by legs 50 and braces 60. Each foldable structure 40 includes a number of hinged connections (not shown) allowing them to be folded onto themselves or onto the roof of the container 20. Further the angles at which the solar panels 30 and the foldable support structures 40 are placed can be changed throughout the day to maximize energy collection, or folded up in instances of high winds or storms.

As regards energy collection, in the example of FIG. 1, the two foldable structures 40 on the long dimensions of the container 20 each have twice the generation capacity of the solar modules on the roof alone, and each of the foldable structures on the short dimension of the container 20 have approximately the same generation capacity as the roof. Thus, by incorporating the four foldable structures, the energy production of the solar panels can increase to about 16.8 kW, with only a small increase in the height of the container 20 when the solar panels 30 and foldable structures 40 are all folded such that they fit within the perimeter of the roof of the container.

Further, one or more wind turbines 70 can be incorporated into the camp energy solution 10. These may be shipped within the container 20 and then deployed on site either as standalone systems (as shown) or with its mast mounted to the container 20. A small wind turbine generator may be, for example, a 5-kW generator, thus in appropriate conditions resulting in a camp energy solution having a peak output of over 21 kW.

Each camp energy solution 10 can therefore effectively provide similar power to 6 of the 3.5 kW gas or diesel generators described above. Moreover, the camp energy solution is highly portable owing to its 20-foot container base allowing the container 20 to be easily trucked to a location or even flown via cargo aircraft (e.g., C-130, C-5, or the CH-47F helicopter, etc.). Thus, the container 20 can be readily implemented for forward deployments or for emergency situations.

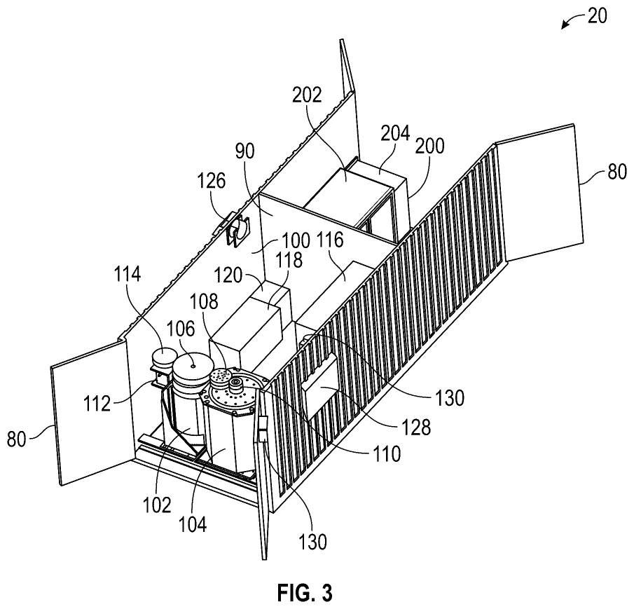

However, as will be appreciated, the sun does not always shine, nor does the wind always blow. Accordingly, an energy storage solution is required. FIG. 3 depicts a perspective internal view of the container 20. On each end of the container 20 two swing doors 80 provide access. A partition 90 separates an energy storage side 100 from a back-up generator side 200.

In the energy storage side is an electrical motor 102 configured to receive energy from the solar panels 30 or wind turbine generator 70. The motor 102 may be a direct current (DC) motor or an alternating current (AC) motor employing a variable frequency drive. The motor 102 is coupled to a flywheel assembly 104, configured to store energy mechanically. The flywheel assembly 104 houses a flywheel weighing 4000-8000 lbs. and spinning at between 5000 and 15,000 RPM. The flywheel thus stores approximately 25 kWh of energy at capacity. Details of flywheel assembly 104 can be found in commonly assigned and co-pending PCT application XXXX titled MECHANICAL RENEWABLE GREEN ENERGY PRODUCTION, filed concurrently herewith the entire contents of which is incorporated herein, and particularly the disclosure related to the flywheels, their construction, and their magnetic bearings.

In one aspect of the disclosure, the motor 102 and flywheel 104 are coupled via a magnetic gearing system allowing for contactless and therefore substantially frictionless. The motor 102 may directly couple with a drive gear 106. The drive gear 106 magnetically couples with an intermediate gear 108 which itself magnetically couples with a pinion gear 110. The pinion gear is mechanically coupled to the flywheel in the flywheel assembly 104. By altering the size of the drive gear 106, intermediate gear 108 and the pinion gear 110, the motor 102 spinning at for example 1800 RPM can cause the flywheel to achieve, for example 10,000 RPM.

Opposite the flywheel assembly 104, and also magnetically coupled to the motor 102 and particularly the drive gear 106 is a generator 112 with a magnetic generator gear 114. When a load is placed on the generator 112, either directly or indirectly, kinetic energy stored in the flywheel assembly 104 is drawn off to spin the generator 112 via the generator gear 114. In this way electrical energy from the solar panels 30 or wind turbine 70 is stored in the flywheel assembly 104 and made available to the generator 112 on demand. By storing energy collected during the day (e.g., via the solar panels 30) the energy is available during the night when the sun is not shining (e.g., at night).

An electrical control locker 116 may be installed within the energy storage side 100. The electrical control locker 116 is configured to receive the output of the solar panels 30 and wind turbine 70 and route the electrical output to the motor 102. Unlike chemical batteries, the flywheel assembly 104, and particularly the flywheel therein can simultaneously charge and discharge energy. Thus, even when there is demand or load on the generator 112 the flywheel assembly 104 can still be charging. In this way, despite daytime loads on the system, energy is nonetheless stored in the flywheel for later use. The electrical control locker may include one or more transformers, rectifiers, inverters, variable frequency drives, and other electrical control and switching mechanisms as necessary to collect, store, and disburse electrical energy.

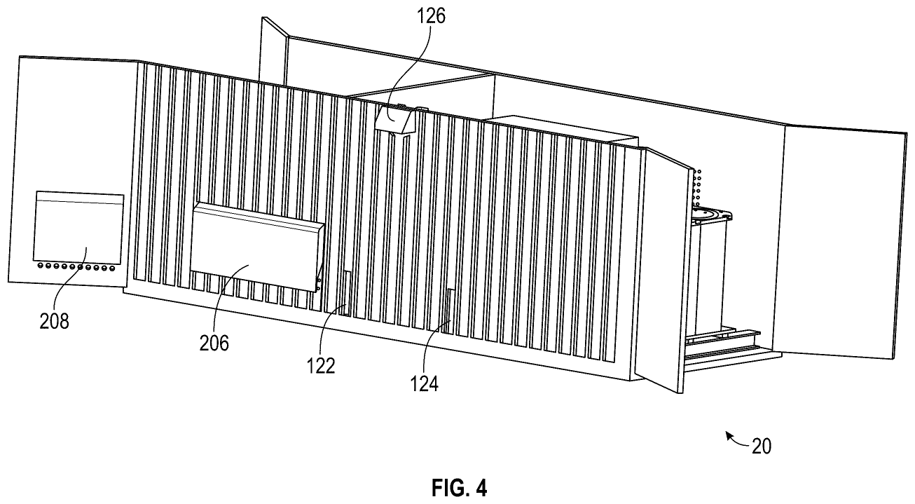

In some environments, (e.g., desert environments) it may be necessary to cool the motor 102, generator 112, electrical control locker 116, and other components of the system. This can be achieved using a water storage tank 118 and an air-water heat exchanger 120. The water is circulated to the motor, generator, or other components to collect heat and then the heated water is directed to the heat exchanger 120 where a fan forces air over coils containing the heated water. The hot air is expelled from the container 20, and thus cools the energy storage side 100 of the container 20. In one aspect of the disclosure, the air used to cool the coils of the heat exchanger 120 never actually enters the energy storage side 100 of container 20. As can be seen in FIG. 4, air is drawn into the heat exchanger 120 via an air inlet 122, remains within the heat exchanger 120, and then is forced from the heat exchanger and out the air outlet 124. Such an arrangement is particularly useful in dusty and sandy environments where the introduction of the particulate matter to the energy storage side of the container 20 will have immediate and negative impacts on the components stored therein. A shrouded exhaust fan 126 evacuates air from the energy storage side 100. Air is allowed to enter the energy storage side 100 via a shrouded air inlet 128 including a filter. By evacuating air from the energy storage side 100 with the exhaust fan 126 a negative air pressure is created in the energy storage side 100 drawing air into the container 20 and minimizing the dust and sand that might be introduced into the container 20 if a fan were employed to force air into the container. In addition to promote further cooling one or more Peltier coolers 130 may be employed directly on the electrical control locker 116 or on the door 80 of the energy storage side 100 or the generator side 200.

In the backup generator side 200, as might be expected is a backup generator 202. The backup generator 202 may be a diesel, gas, propane, or natural gas generator, for example a 5, 10, 15, 20, 25, 30, 35, 40, 45, or 50 KW generator. In one example, a 50-kW generator is employed. As will be appreciated, a 50 KW generator is capable of fully charging a 25 kW flywheel assembly 104 in approximately ½ an hour. As the name suggests, the back-up generator 202 is for the purpose of charging the flywheel assembly 104 when other charging sources are unavailable (e.g., at night when no wind or too much wind is blowing). In this way the generator 202 can be employed for a short duration at approximately 85% of rated capacity to provide efficient energy generation and storage of the produced energy. Those of skill in the art will recognize that neither a lightly loaded nor capacity loaded generator is particularly efficient, however, generally peak efficiency for the generator is achieved at about 85% rated load, thus the flywheel assembly 104 by being a load to be powered provides an efficiency boost for the energy production and storage.

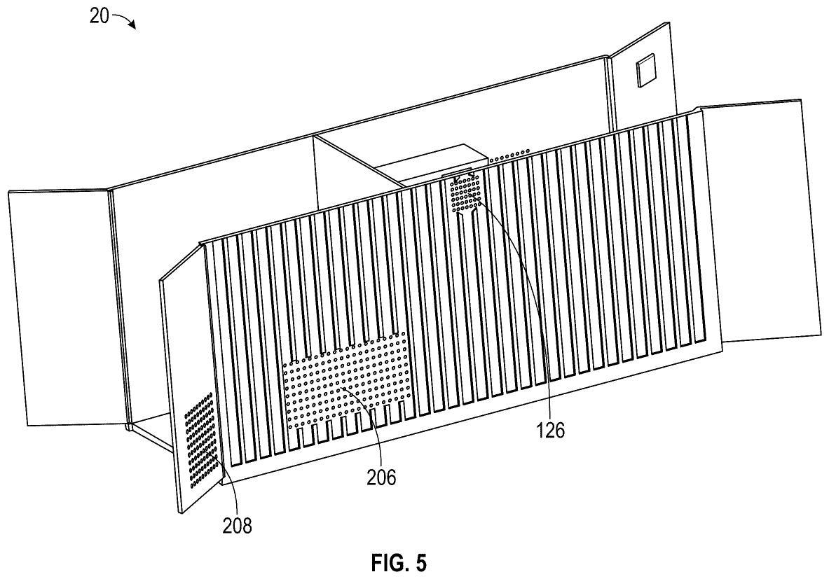

To improve environmental factors, a baffle or other noise abatement features 204 may be incorporated into the backup generator side 200. An intake shroud 206 can be placed on an exterior of the container 20 to limit the intake of dust and sand into the generator side 200 of the container. An exhaust shroud 208 can be employed in combination with the baffle or noise abatement features 204 to further limit noise issues. FIG. 5 depicts the perforations made in the container 20 to enable the exhaust fan 126, the generator air intake 206, and the generator exhaust 208. Each set of perforations may include screening to prevent ingress of insects and animals.

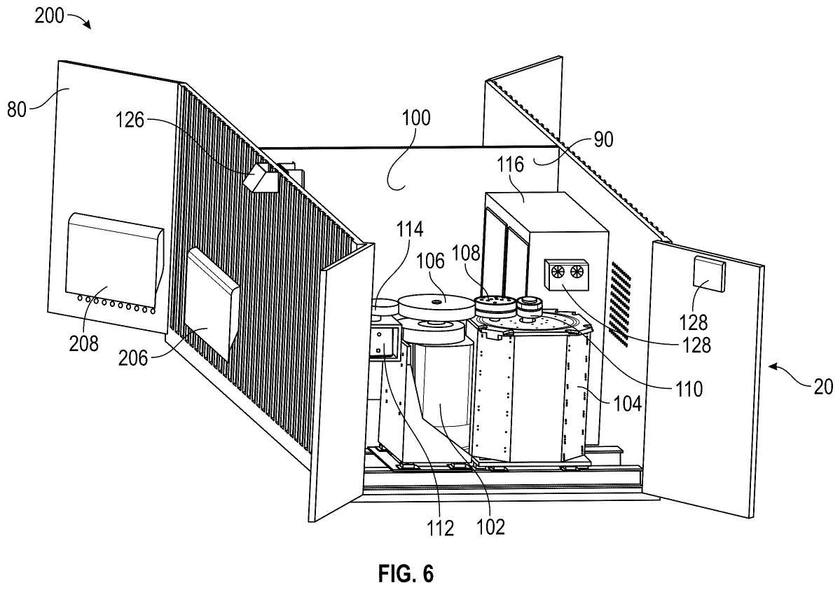

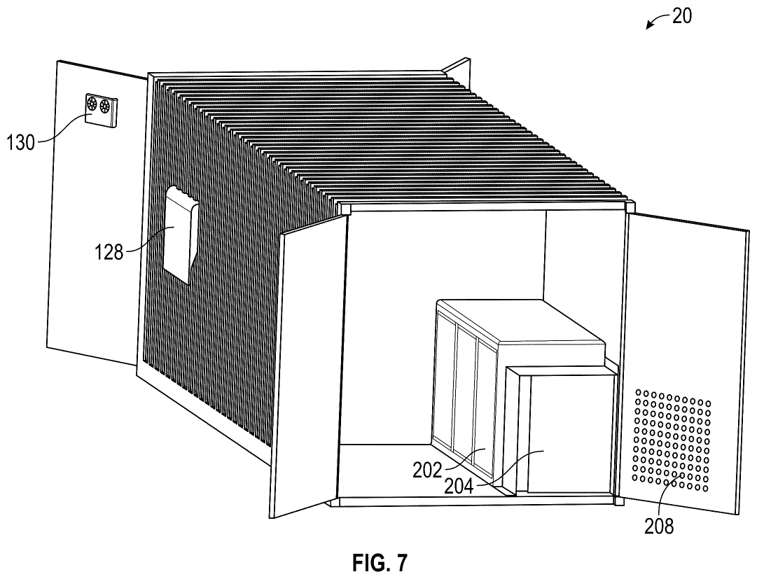

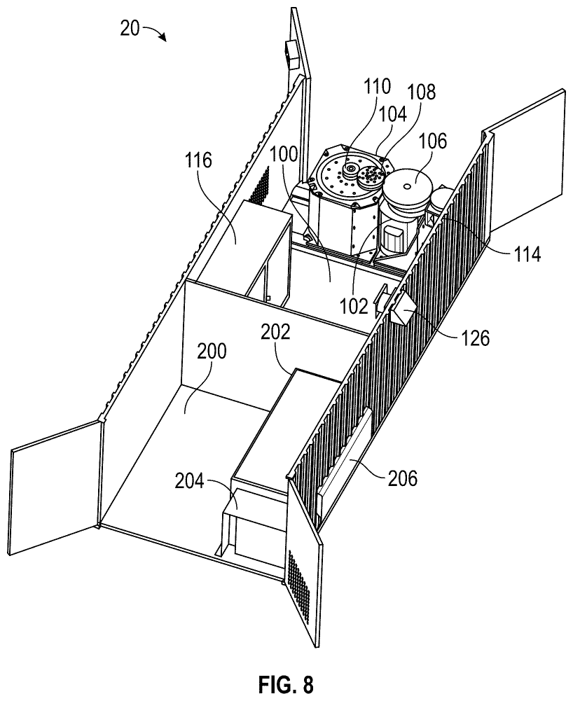

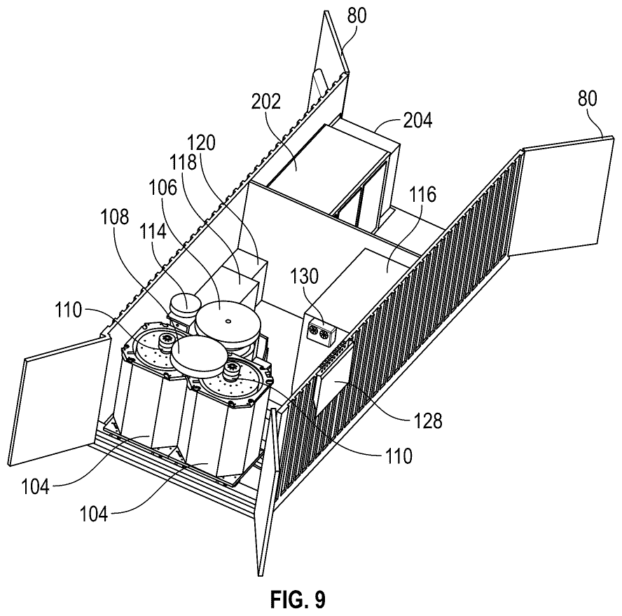

FIG. 6-8 provide views of container 20 of FIG. 3 depicting the relative placement of the components described above. FIG. 9 depicts a further embodiment of the disclosure in which 2 25 kWh flywheel assemblies are deployed increasing the number of 3.5.kW generators that can be replaced by the camp energy solution 10.

Still further, with the camp energy solution 10, a number of housing containers 20 can be similarly deployed. Each housing container 20 may be outfitted with beds, a toilet, a shower, lighting, and air conditioning making each container suitable or housing 4-8 personnel in either a forward deployment or an emergency response scenario. The containers 20 may then be electrically connected to the camp energy solution 10 to provide the necessary power. Further, alternative uses for containers 20 including office space, radio equipment, and other may be employed without departing from the scope of the disclosure. Regardless of the use of the containers 20, the camp energy solution 10 provides the necessary power.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. A remote energy system comprising:
a container, the container including a partition separating the container into a generator side and an energy storage side;
a motor secured in the energy storage side of the container, the motor configured to receive energy from one or more renewable energy sources;
a flywheel assembly magnetically coupled to the motor, the flywheel assembly configured to store kinetic energy;
an electrical generator magnetically coupled to the motor or the flywheel and configured to supply electrical energy to a load; and
a fuel powered generator secured in the generator side of the container and configured to provide electrical energy to the motor.

2. The remote energy system of claim 1, further comprising a plurality of solar panels electrically connected to the motor.

3. The remote energy system of claim 2, wherein the plurality of solar panels are secured to a roof of the container.

4. The remote energy system of claim 3, further comprising a plurality of foldable structures.

5. The remote energy system of claim 4, wherein each foldable structure supports a second plurality of solar panels.

6. The remote energy system of claim 2, further comprising a wind turbine generator electrically connected to the motor.

7. The remote energy system of claim 2, further comprising a water storage tank and heat exchanger operably connected to the generator to cool the generator.

8. The remote energy system of claim 7, wherein the heat exchanger is configured to prevent ingress of air into the container.

9. The remote energy system of claim 2, further comprising an exhaust fan exhausting air from the energy storage side of the container.

10. The remote energy system of claim 7, further comprising an air inlet, the air inlet including a filter limiting ingress of sand and dirt into the container.

11. The remote energy system of claim 2, wherein the flywheel assembly includes a flywheel storing about 25 kWh of energy.

12. The remote energy system of claim 2, wherein the flywheel assembly includes a pair of flywheels storing about 50 kWh of energy.

13. The remote energy system of claim 2, wherein the fuel powered generator generates about 50 kW.

14. The remote energy system of claim 2, further comprising an electrical control cabinet, the electrical control cabinet enabling the connection of the electrical generator with a load external to the container such that kinetic energy stored in the flywheel is converted to electrical energy and applied to the load.

15. The remote energy storage system of claim 2, wherein the container is sized to be carried by an aircraft or truck.
